(19) United States
(12) Patent Application Publication
(10) Pub. No.: US 2015/0180816 A1
(43) Pub. Date: Jun. 25, 2015

(54) Customized Location Notification

(71) Applicant: Apple Inc., Cupertino, CA (US)

(72) Inventors: Devrim Varoglu, Santa Clara, CA (US); Swapnil R. Dave, Santa Clara, CA (US)

(73) Assignee: Apple Inc., Cupertino, CA (US)

(21) Appl. No.: 14/137,985

(22) Filed: Dec. 20, 2013

(51) Int. Cl. H04L 12/58; H04L 29/08

(52) U.S. Cl. CPC H04L 51/24; H04L 51/20; H04L 67/18

(57) ABSTRACT

A location-aware device operated by a first user allows the first user to request a custom notification from a second user upon the occurrence of a custom notification event specified by the first user. The custom notifications can be sent automatically from the second user's device in a text message session, e-mail thread, as an automated telephone message or by using any other available communication mode. In some implementations, the first user can request receipt of a custom notification upon occurrence of a custom notification event that is related to a POI specified by the first user.

### TECHNICAL FIELD

This disclosure relates generally to location-based services.

### BACKGROUND

Many modern mobile devices (e.g., a smart phone, e-tablet, wearable devices) include a navigation system. The navigation system can include a microprocessor that executes a software navigation application that uses data from one or more inertial sensors (e.g., accelerometer, gyro, magnetometer) and a positioning system (e.g., satellite-based, network-based) to determine the current location and direction of travel of the mobile device. The navigation application allows a user to input a desired destination and calculates a route from the current location to the destination according to the user's preferences. A map display includes markers to show the current location of the mobile device, the desired destination and points of interest (POIs) along the route. Some navigation applications can provide a user with turn-by-turn directions. The directions can be presented to the user on the map display and/or by a navigation assistant through audio output.

In addition to a navigation system, many modern mobile devices include various modes of communicating with other devices, including e-mail, text messaging and cellular communications. Some devices include a reminder system where a user can request to receive notifications when the user has entered or exited a particular location. For example, a user can receive a reminder whenever the user leaves their home or work.

There are often times when an individual at a destination of a route traveled by a friend, family member or other traveling party would like to know when the traveling party will arrive at the destination. For example, if a dinner party is planned at the destination, it would be helpful for the host to know when the guests have arrived or will soon be arriving. The conventional solution to this problem is to call the traveling party and ask them for their estimated time of arrival (ETA). However, the traveling party may not be in a position to answer the call. Even if an ETA is obtained from the travelling party, the ETA can change for a variety of reasons, such as traffic congestion or an accident on the route, necessitating another call to the traveling party to request an updated ETA.

### SUMMARY

A location-aware device operated by a first user allows the first user to request a custom notification from a second user upon the occurrence of a custom notification event specified by the first user. The custom notifications can be sent automatically from the second user's device in a text message session, e-mail thread, as an automated telephone message or by any other available communication mode. In some implementations, the first user can request receipt of a custom notification upon occurrence of a custom notification event that is related to a POI specified by the first user. In such implementations, the first user can specify a generic (e.g., supermarket, drugstore) or specific POI (e.g., Safeway™, CVS™) and an ETA to the specified POI for the second user from a current location on the route. Custom notifications are then sent to the first user when the second user enters or exits an area surrounding the POI.

In some implementations, a method performed by a first device in communication with a second device comprises: detecting an occurrence of a custom notification event specified by the second device; responsive to detection of the custom notification event, determining an estimated time of arrival to a destination or a point of interest; obtaining or generating a custom notification including the estimated time of arrival; and sending the custom notification to the second device.

In some implementations, a method performed by a first device in communication with a second device comprises: obtaining input specifying a notification event; receiving a custom notification from the second device upon occurrence of the specified notification event, the custom notification including an estimated time of arrival to a destination or point of interest; and responsive to receiving the custom notification, sending information related to the custom notification event to the second device.

Other implementations are directed to devices and computer-readable mediums.

Particular implementations disclosed herein provide one or more of the following advantages. Custom notifications inform users of impending arrivals of a traveling party or other activities using communication technologies typically included in modern mobile devices. The user does not have to use a generic set of notifications determined by an application developer. Rather, the mobile device can facilitate the user's creation of custom notifications that are tailored to the user's needs. The communication of notifications between devices can be peer-to-peer using e-mail, text messaging or cellular communications (e.g., automated messages), which protects the privacy of the user and eliminates the need for the user to subscribe to a centralized location-based service (e.g., tracking service).

The details of the disclosed implementations are set forth in the accompanying drawings and the description below. Other features, objects and advantages are apparent from the description, drawings and claims.

### DESCRIPTION OF DRAWINGS

FIG. 1 illustrates an example custom notification system.

FIG. 2 illustrates an example settings pane for setting custom notifications.

FIG. 3 is a flow diagram of an example process for generating and sending custom notifications.

FIG. 4 is a flow diagram of an example process for requesting and receiving custom notifications.

FIG. 5 is a flow diagram of an example process for generating and sending custom notifications related to POI.

FIG. 6 is a flow diagram of an example process for requesting and receiving custom notifications related to POI.

FIG. 7 is a block diagram of exemplary device architecture for implementing the features and processes described in reference to FIGS. 1-6.

The same reference symbol used in various drawings indicates like elements.

### DETAILED DESCRIPTION

### Example System

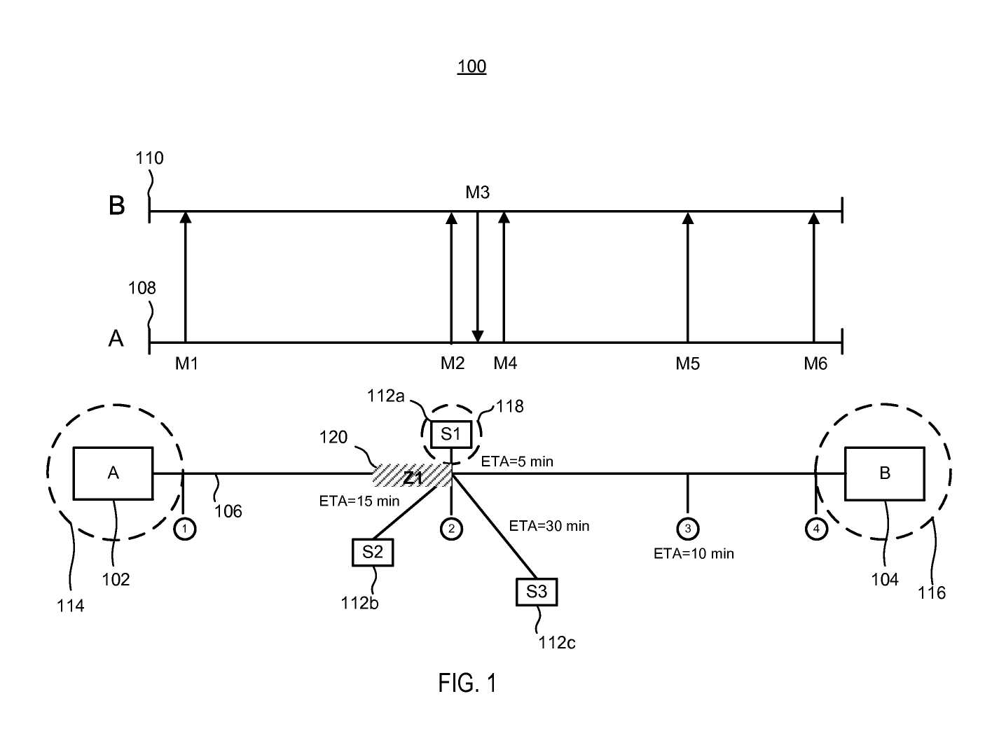

FIG. 1 illustrates an example custom notification system 100. In some implementations, system 100 includes location-aware devices 102, 104. Devices 102, 104 can be any device capable of determining or obtaining its location and communicating with other devices. Some examples of devices 102, 104 include but are not limited to: smart phones, electronic tablets, notebook computers, navigation devices (including vehicle or vessel navigation systems and docked navigation devices) and wearable devices. Devices 102, 104 can communicate using any know communication mode including but not limited to: e-mail, text messaging, cellular calls, paging, tweets and push notifications. Devices 102, 104 can determine their locations using any known positioning technology, including satellite-based (e.g., GPS) or network based (e.g., Wi-Fi, cellular)

The operation of custom notification system 100 will now be described using an example use case. In this example use case, User A operating device 102 (device “A”) has been invited to dinner at User B's house. User B operates device 104 (device “B”). User B would like to know when User A has departed from User A's home and when User A has arrived at User B's home. Additionally, User B would like to know when User A is within 10 minutes of User B's house. User B would also like to know when User A is within 5 minutes of a supermarket at any location along route 106 between User A's home and User B's home. This example use case includes 4 custom notification events, which are indicated in FIG. 1 with circled numbers.

User B sends a request to User A's device 102 to send custom notifications to User B's device 104 each time a custom notification event occurs while User A is travelling along route 106. User A can reject or accept the request. For this example, User A has accepted the request. Upon acceptance, User B's device sends custom notification event data to User A's device. The notification event data can be used by User A's device 102 to detect a custom notification event, obtain or generate a custom notification for the event and to send the custom notification to User B's device 104. In this example, the request/acceptance and custom notifications are sent in a text session between User A and User B. Other communication modes can be used as well, including e-mail and cellular communications.

User A generates a route using a navigation application on device 102. If User B requested route sharing, device 102 sends route information to device 104. A first custom notification event occurs when User A has departed from their home. The trigger event for departure can be the crossing of a geo-fence surrounding the departure location, which in this example is User A's house. A geofence is a virtual perimeter for a real-world geographic area. The geofence can be dynamically generated by defining a radius around a point location or can be a predefined set of boundaries. When User A crosses geo-fence 114 (custom notification event 1), a custom notification M1 (e.g., a text message) is sent to User B's device 104. Note that timelines 108, 110 in FIG. 1 illustrate the sending and receiving of text messages between User A and User B upon the occurrence of a custom notification event. The direction of the arrow indicates the direction of the text message transmission.

The second custom notification event (custom notification event 2) occurs when User A's device detects that User A is 5 minutes from a POI (e.g., a supermarket). Both the POI and the ETA of 5 minutes was specified by User B and included in the notification event data transferred to User A's device 102. In this example, there were three supermarkets near User A (S1, S2, S3). Supermarket 112a (S1) met the ETA condition specified by User B. User A's device 102 obtains or generates the custom notification M2 and sends the custom notification to User B. For example, the custom notification could be “User A is 5 minutes from a supermarket.” In response to this message, User B can send a message M3 to User A asking User A to stop at the supermarket. For example, “Hi User A. Please stop at the supermarket and pick up an apple pie for dessert.” In some implementations, User A's device can show a marker for the supermarket on a map display and optionally compute a route to supermarket 112a. In some implementations, a navigation assistant can provide audible instructions, such as “User B would like you to pick up an apple pie at supermarket S1. I have computed a route to supermarket S1 for you. The ETA to the supermarket is 5 minutes. Please say yes to accept or cancel to resume route navigation.” If User A accepts the offer from User B, a route and turn-by-turn directions can be provided to User A. Additionally, a message M4 can be sent to User B notifying User B that A has accepted the offer to go to supermarket 112a. In some implementations, message M4 can include or have attached a shopping list that was previously prepared by User B. The shopping list can be generic for all supermarkets or tailored to a specific supermarket. The shopping list can be prepared on the device 104 using, for example, a calendar application with a task option, a notes application or reminder application.

Geo-fence 118 specified by User B (e.g., a radius) will detect when User A arrives and departs from supermarket 112a, and additional messages can be sent to User A to indicate the arrival/departure events. In some implementations, the size of geo-fence 118 for a POI can be set to a default radius (e.g., 100 feet).

A third custom notification event (custom notification 3) occurs when User A's device 102 detects that User A is 10 minutes from the destination or User B's house. The ETA can be computed using known formulas that take into account User A's distance from the destination or POI and the speed of User A (e.g., ETA=distance/speed). Other variables like an estimated delay due to traffic can be used to update the ETA. An example custom notification may be “User A is now 10 minutes away.” The custom notification can be displayed as text or graphics on the map display and/or provided by a navigation assistant using audio output.

A fourth and final custom notification event (custom notification 4) occurs when User A's device 102 crosses geo-fence 116, surrounding User B's house. Upon occurrence of this notification event, a message M6 is sent to User B indicating the arrival of User A.

An important take away from the use case described above is that User B (not User A) specifies the custom notification events. User A just needs to accept User B's request for custom notifications. Notification events are automatically sent to User B including instructions for a detour to any POI specified by User B. A request for a detour from the route (e.g., detour to a supermarket) can be accepted or rejected by User A. Using system 100, User B does not have to repeatedly call User A to find out User A's ETA or whether User A will go to the supermarket.

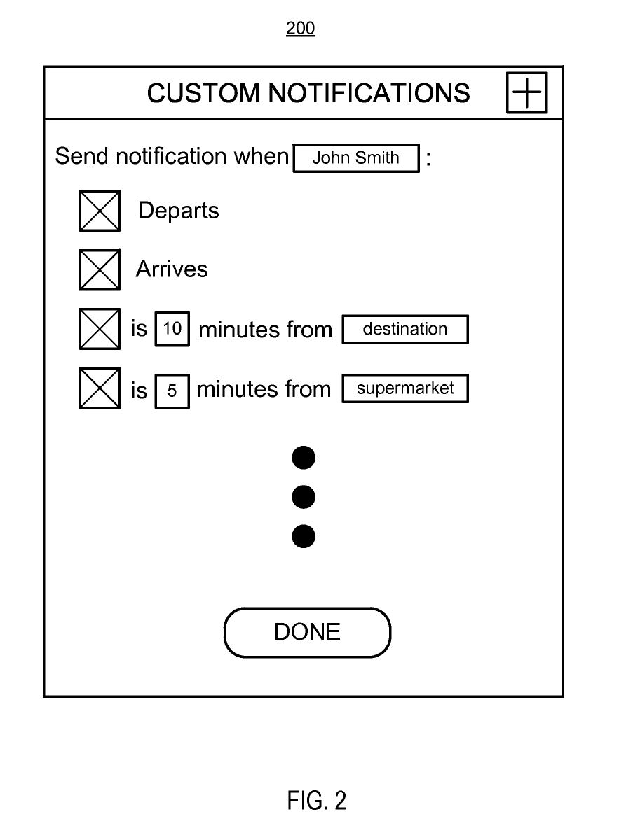

FIG. 2 illustrates an example settings pane 200 for setting custom notifications. Settings pane 200 can be presented on a display of User B's device 104. User B can specify the name of the user that the custom notification request will be sent to. For example, User B can type in the name of User A, which can be compared against a contact database (local or remote) to get the telephone number of User A's device 102. In some implementations, User B can enter User A's telephone number instead of their name.

In the example shown, pane 200 includes several options that can be selected by a check box. The options are “departs,” “arrives,” “is within x minutes of destination” and “is within x minutes of POI.” Other options are also possible. Other input or selection mechanisms can be used instead of or in addition to a check box. The POI can be generic (e.g., supermarket) or specific (e.g., Safeway™). In some implementations, User B's device 104 or User A's device 102 can search for the locations of a specified POI that are within a defined distance of the route and store those locations on device 102 before User A embarks on the route. Knowing the locations of the specified POI a priori allow notification event trigger zones to be set by device 102 along route 106. For example, when User A enters the notification event trigger zone 120 (Z1), ETAs to each of the POI (e.g., S1, S2, S3) can be determined based on the current speed of User A. A comparison of the ETAs for the POI can be compared to the ETA specified by User B, which is 5 minutes in this example. The POI with the closest ETA to the one specified by User B is selected for presentation to User A.

### Example Processes

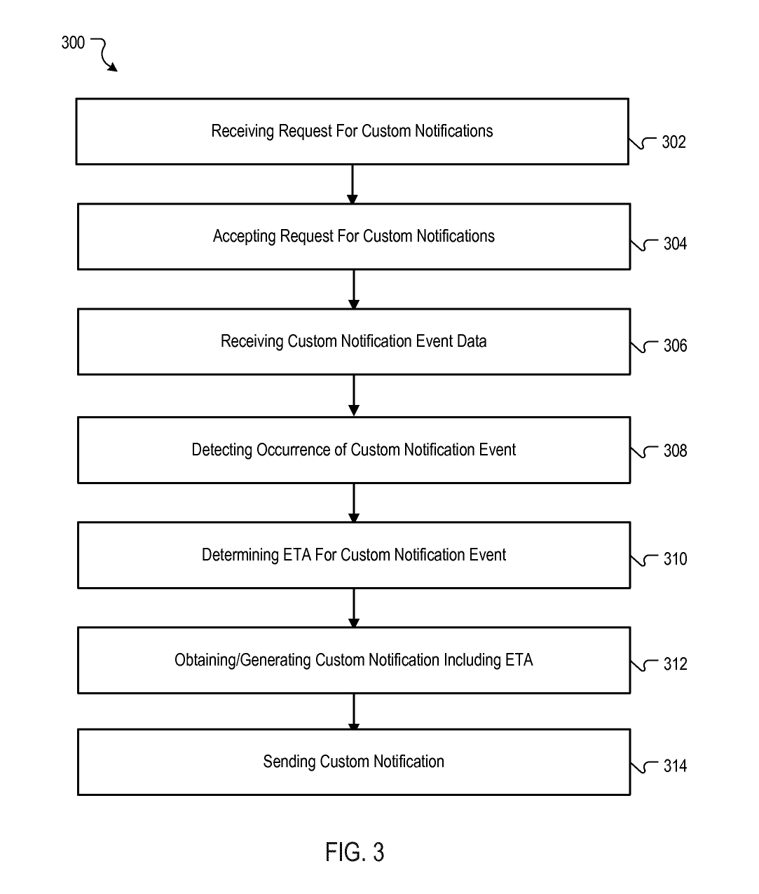

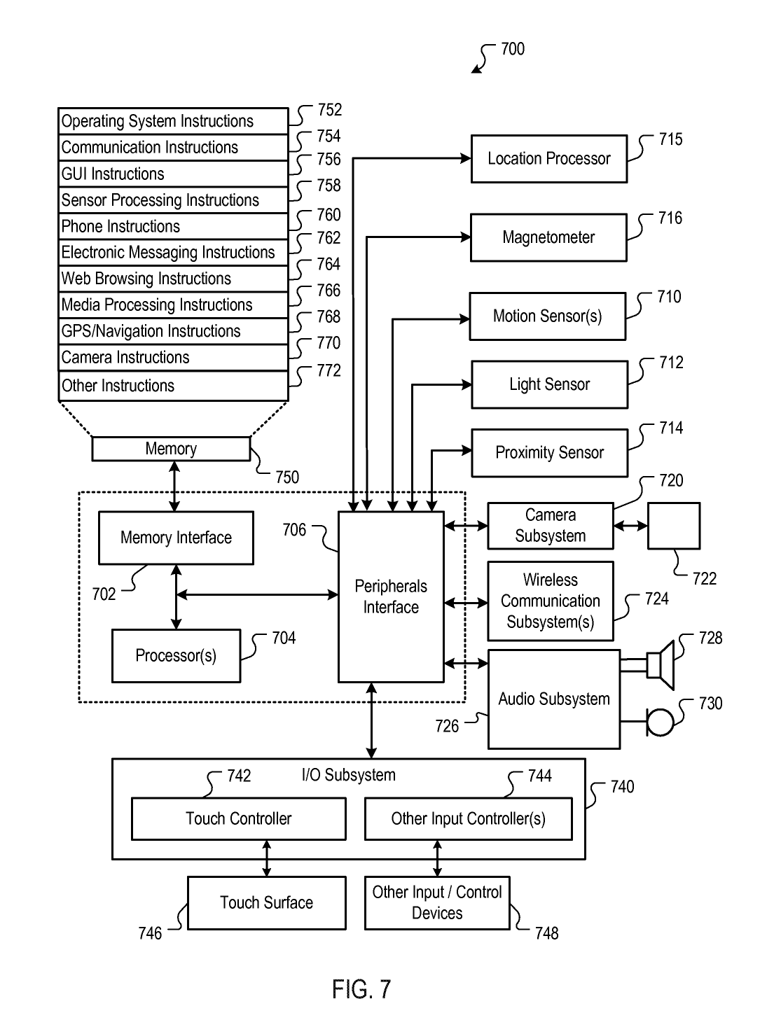

FIG. 3 is a flow diagram of an example process 300 for generating and sending custom notifications. Process 300 can be implemented by the device architecture described in reference to FIG. 7.

In some implementations, process 300 can begin by a first device receiving a request for custom notifications from a second device (302) and the first device accepting the request (304). For example, a user of the second device can send a text message, e-mail or other communication to the user of the first device. If the user of the first device accepts the request, a communication session is established for custom notifications (e.g., a text messaging session) between the first and second devices.

Process 300 can continue by the first device receiving custom notification event data from the second device (306). The custom notification event data can include a description of the event and content (e.g., text, graphics) that can be used by the first device to detect custom notification events and generate and send custom notifications for the events to the second device.

Process 300 can continue as the user of the first device travels along a route and the first device detects an occurrence of a custom notification event (308). For example, a custom notification can be sent to the second device when the first device departs from the departure location. A departure can be detected using a geo-fence as described in reference to FIG. 1. Another example custom notification event is when the first device is within a specified ETA of POI. The POI can be any point location, such as a supermarket or drugstore. The POI is specified by the user of the second device. The first device can optionally generate the route and share it with the second device upon request from the second device.

Another example custom notification event is when the first device is within a specified ETA of the destination. Yet another example custom notification event is when the first device arrives at the destination. Like departures, arrivals can also be detected by a geo-fence crossing, as described in reference to FIG. 1. For custom notification events that are related to an ETA, process 300 can continue by the first device determining an ETA for the custom notification event (310). The ETA can be calculated based on the distance to the destination or POI and the speed of the first device (e.g., ETA=distance/speed). A delay due to traffic can be added to the ETA to improve the accuracy of the ETA.

Process 300 can continue by the first device obtaining or generating a custom notification including the determined ETA (312). The custom notification can be provided by the second device as part of the custom notification data previously transferred to the first device or a default notification stored on the first device. In some implementations, the custom notification can be generated on the fly by the first device each time a custom notification event occurs.

Process 300 can continue by the first device sending the custom notification to the second device (314). The custom notification can be displayed as text with or without graphics or presented by a navigation assistant as audio output.

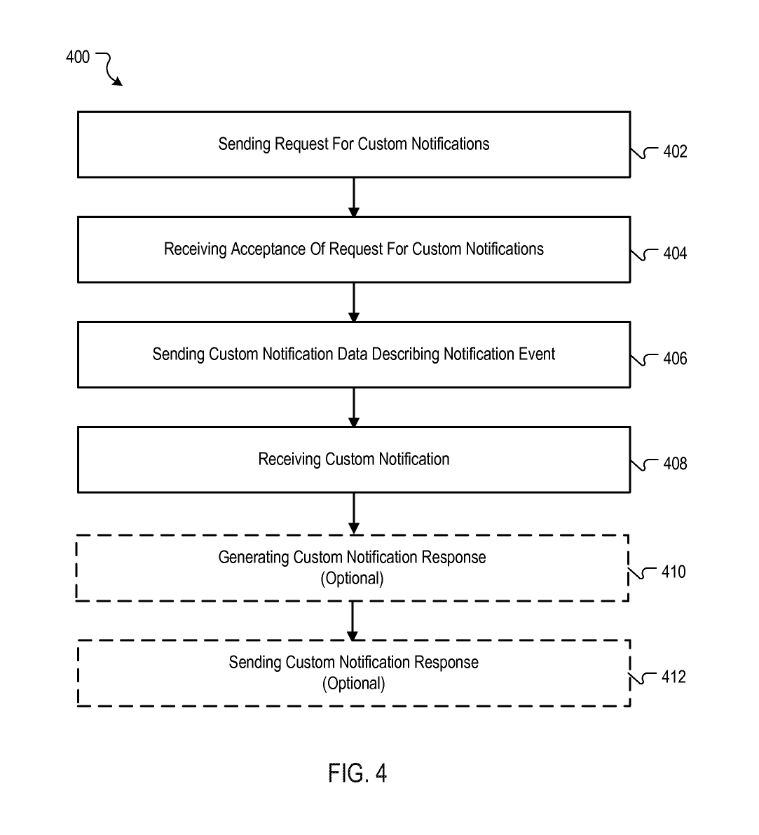

FIG. 4 is a flow diagram of an example process 400 for requesting and receiving custom notifications. Process 400 can be implemented by the device architecture described in reference to FIG. 7.

Process 400 can begin by sending, by a first device, a request for custom notifications to a second device (402) and receiving an acceptance from the second device (404).

Process 400 can continue by the first device sending custom notification data describing a notification event to the second device (406). For example, the custom notification event data can include a description of the event and content (e.g., text, graphics) that can be used by the second device to detect the custom notification event and generate and send a custom notification to the first device.

Process 400 can continue by the first device receiving a custom notification from the second device (408) and optionally obtaining or generating a response to the custom notification (410) and sending the response to the second device (412).

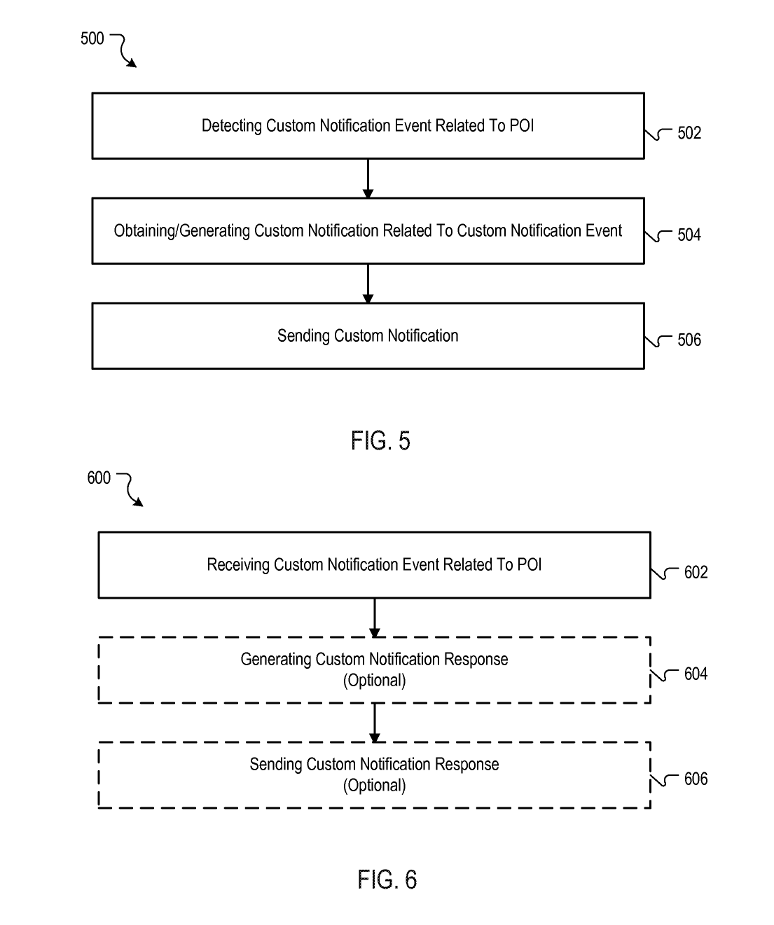

FIG. 5 is a flow diagram of an example process 500 for generating and sending custom notifications related to POI. Process 500 can be implemented by the device architecture described in reference to FIG. 7.

Process 500 can begin by detecting, by a first device, a custom notification event related to a POI (502), then obtaining or generating a custom notification related to the custom notification event (504) and sending the custom notification to a second device (506).

FIG. 6 is a flow diagram of an example process for requesting and receiving custom notifications related to POI. Process 600 can be implemented by the device architecture described in reference to FIG. 7.

Process 600 can begin by receiving, by a first device, a custom notification event related to a POI (602), then optionally obtaining or generating, by the second device, a response to the custom notification (604) and sending the response to the first device (606).

### Example Mobile Device Architecture

FIG. 7 is a block diagram of exemplary device architecture for implementing the features and processes described in reference to FIGS. 1-6.

Architecture 700 may be implemented in any device for generating the features described in reference to FIGS. 1-6, including but not limited to portable or desktop computers, smart phones and electronic tablets, television systems, game consoles, kiosks and the like. Architecture 700 may include memory interface 702, data processor(s), image processor(s) or central processing unit(s) 704, and peripherals interface 706. Memory interface 702, processor(s) 704 or peripherals interface 706 may be separate components or may be integrated in one or more integrated circuits. One or more communication buses or signal lines may couple the various components.

Sensors, devices, and subsystems may be coupled to peripherals interface 706 to facilitate multiple functionalities. For example, motion sensor 710, light sensor 712, and proximity sensor 714 may be coupled to peripherals interface 706 to facilitate orientation, lighting, and proximity functions of the device. For example, in some implementations, light sensor 712 may be utilized to facilitate adjusting the brightness of touch surface 746. In some implementations, motion sensor 710 (e.g., an accelerometer, gyros) may be utilized to detect movement and orientation of the device. Accordingly, display objects or media may be presented according to a detected orientation (e.g., portrait or landscape).

Other sensors may also be connected to peripherals interface 706, such as a temperature sensor, a biometric sensor, or other sensing device, to facilitate related functionalities.

Location processor 715 (e.g., GPS receiver) may be connected to peripherals interface 706 to provide geo-positioning. Electronic magnetometer 716 (e.g., an integrated circuit chip) may also be connected to peripherals interface 706 to provide data that may be used to determine the direction of magnetic North. Thus, electronic magnetometer 716 may be used as an electronic compass.

Camera subsystem 720 and an optical sensor 722, e.g., a charged coupled device (CCD) or a complementary metal-oxide semiconductor (CMOS) optical sensor, may be utilized to facilitate camera functions, such as recording photographs and video clips.

Communication functions may be facilitated through one or more communication subsystems 724. Communication subsystem(s) 724 may include one or more wireless communication subsystems. Wireless communication subsystems 724 may include radio frequency receivers and transmitters and/or optical (e.g., infrared) receivers and transmitters. Wired communication system may include a port device, e.g., a Universal Serial Bus (USB) port or some other wired port connection that may be used to establish a wired connection to other computing devices, such as other communication devices, network access devices, a personal computer, a printer, a display screen, or other processing devices capable of receiving or transmitting data.

The specific design and implementation of the communication subsystem 724 may depend on the communication network(s) or medium(s) over which the device is intended to operate. For example, a device may include wireless communication subsystems designed to operate over a global system for mobile communications (GSM) network, a GPRS network, an enhanced data GSM environment (EDGE) network, 802.x communication networks (e.g., Wi-Fi, Wi-Max), code division multiple access (CDMA) networks, and a Bluetooth™ network. Communication subsystems 724 may include hosting protocols such that the device may be configured as a base station for other wireless devices. As another example, the communication subsystems may allow the device to synchronize with a host device using one or more protocols, such as, for example, the TCP/IP protocol, HTTP protocol, UDP protocol, and any other known protocol.

Audio subsystem 726 may be coupled to a speaker 728 and one or more microphones 730 to facilitate voice-enabled functions, such as voice recognition, voice replication, digital recording, and telephony functions.

I/O subsystem 740 may include touch controller 742 and/or other input controller(s) 744. Touch controller 742 may be coupled to a touch surface 746. Touch surface 746 and touch controller 742 may, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch surface 746. In one implementation, touch surface 746 may display virtual or soft buttons and a virtual keyboard, which may be used as an input/output device by the user.

Other input controller(s) 744 may be coupled to other input/control devices 748, such as one or more buttons, rocker switches, thumb-wheel, infrared port, USB port, and/or a pointer device such as a stylus. The one or more buttons (not shown) may include an up/down button for volume control of speaker 728 and/or microphone 730.

In some implementations, device 700 may present recorded audio and/or video files, such as MP3, AAC, and MPEG files. In some implementations, device 700 may include the functionality of an MP3 player and may include a pin connector for tethering to other devices. Other input/output and control devices may be used.

Memory interface 702 may be coupled to memory 750. Memory 750 may include high-speed random access memory or non-volatile memory, such as one or more magnetic disk storage devices, one or more optical storage devices, or flash memory (e.g., NAND, NOR). Memory 750 may store operating system 752, such as Darwin, RTXC, LINUX, UNIX, OS X, WINDOWS, or an embedded operating system such as VxWorks. Operating system 752 may include instructions for handling basic system services and for performing hardware dependent tasks. In some implementations, operating system 752 may include a kernel (e.g., UNIX kernel).

Memory 750 may also store communication instructions 754 to facilitate communicating with one or more additional devices, one or more computers or servers. Communication instructions 754 may also be used to select an operational mode or communication medium for use by the device, based on a geographic location (obtained by the GPS/Navigation instructions 768) of the device. Memory 750 may include graphical user interface instructions 756 to facilitate graphic user interface processing, including a touch model for interpreting touch inputs and gestures; sensor processing instructions 758 to facilitate sensor-related processing and functions; phone instructions 760 to facilitate phone-related processes and functions; electronic messaging instructions 762 to facilitate electronic-messaging related processes and functions; web browsing instructions 764 to facilitate web browsing-related processes and functions; media processing instructions 766 to facilitate media processing-related processes and functions; GPS/Navigation instructions 768 to facilitate GPS and navigation-related processes, such as the processes described in reference to FIGS. 1-6; camera instructions 770 to facilitate camera-related processes and functions; and instructions 772 for implementing some or all of the features and processes described in reference to FIGS. 1-6.

Each of the above identified instructions and applications may correspond to a set of instructions for performing one or more functions described above. These instructions need not be implemented as separate software programs, procedures, or modules. Memory 750 may include additional instructions or fewer instructions. Furthermore, various functions of the device may be implemented in hardware and/or in software, including in one or more signal processing and/or application specific integrated circuits.

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with an author, the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

A number of implementations have been described. Nevertheless, it will be understood that various modifications may be made. The systems and techniques presented herein are also applicable to other electronic text such as electronic newspaper, electronic magazine, electronic documents etc. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method performed by a first device in communication with a second device, the method comprising:
detecting an occurrence of a custom notification event specified by the second device;
responsive to detection of the custom notification event, determining an estimated time of arrival to a destination or a point of interest;
obtaining or generating a custom notification including the estimated time of arrival; and
sending the custom notification to the second device,
where the method is performed by one or more hardware processors.

2. The method of claim 1, further comprising:
receiving a request for custom notifications from the second device; and
accepting the request for custom notifications.

3. The method of claim 1, further comprising:
sharing the route with the second device.

4. The method of claim 1, where the first device is in peer-to-peer communication with the second device.

5. The method of claim 1, where the first device communicates with the second device in a text messaging session.

6. The method of claim 1, where the custom notification event is the first device departing from or arriving to the destination or point of interest.

7. The method of claim 6, where departing from or arriving to the destination or point of interest is determined based on the first device entering or exiting a geographic region containing the destination or point of interest, and where the size of the geographic region is specified by the second device.

8. The method of claim 1, where the custom notification event is based on a comparison of the determined estimated time of arrival to an estimated time of arrival specified by the second device.

9. A method performed by a first device in communication with a second device, the method comprising:
obtaining input specifying a notification event;
receiving a custom notification from the second device upon occurrence of the specified notification event, the custom notification including an estimated time of arrival to a destination or point of interest; and
responsive to receiving the custom notification, sending information related to the custom notification event to the second device,
where the method is performed by one or more hardware processors.

10. The method of claim 9, further comprising:
sending a request for custom notifications to the second device; and
receiving an acceptance of the request for custom notifications from the second device.

11. The method of claim 9, further comprising:
receiving the route from the second device.

12. The method of claim 9, where the first device is in peer-to-peer communication with the second device.

13. The method of claim 9, where the first device communicates with the second device in a text messaging session.

14. The method of claim 9, where the custom notification event is the second device departing from or arriving to the destination or point of interest.

15. The method of claim 14, where departing from or arriving to the destination or point of interest is determined based on the second device entering or exiting a geographic region containing the destination or point of interest, and where the size of the geographic region is specified by the first device.

16. The method of claim 9, where the custom notification event is based on a comparison of the determined estimated time of arrival to an estimated time of arrival specified by the first device.

17. A system comprising:
one or more processors;
memory coupled to the one or more processors and configured to store instructions, which, when executed by the one or more processors, causes the one or more processors to perform operations comprising:
detecting an occurrence of a custom notification event specified by a device;
responsive to detection of the custom notification event, determining an estimated time of arrival to a destination or a point of interest;
obtaining or generating a custom notification including the estimated time of arrival; and
sending the custom notification to the device.

18. The system of claim 17, further comprising:
receiving a request for custom notifications from the device; and
accepting the request for custom notifications.

19. The system of claim 17, further comprising:
sharing the route with the second device.

20. The system of claim 17, where the system is in peer-to-peer communication with the device.

21. The system of claim 17, where the system communicates with the device in a text messaging session.

22. The system of claim 17, where the custom notification event is the system departing from or arriving to the destination or point of interest.

23. The system of claim 22, where departing from or arriving to the destination or point of interest is determined based on the system entering or exiting a geographic region containing the destination or point of interest, and where the size of the geographic region is specified by the device.

24. The system of claim 17, where the custom notification event is based on a comparison of the determined estimated time of arrival to an estimated time of arrival specified by the device.

25. A system comprising:
one or more processors;
memory coupled to the one or more processors and configured to store instructions, which, when executed by the one or more processors, causes the one or more processors to perform operations comprising:
obtaining input specifying a notification;
receiving a custom notification from the device upon occurrence of the specified notification event, the custom notification including an estimated time of arrival to a destination or point of interest; and
responsive to receiving the custom notification, sending information related to the custom notification event to the device.

26. The system of claim 25, further comprising:
sending a request for custom notifications to the device; and
receiving an acceptance of the request for custom notifications from the device.

27. The system of claim 25, further comprising:
receiving the route from the second device.

28. The system of claim 25, where the system is in peer-to-peer communication with the second device.

29. The system of claim 25, where the system communicates with the device in a text messaging session.

30. The system of claim 25, where the custom notification event is the device departing from or arriving to the destination or point of interest.

31. The system of claim 30, where departing from or arriving to the destination or point of interest is determined based on the device entering or exiting a geographic region containing the destination or point of interest, and where the size of the geographic region is specified by the system.

32. The system of claim 25, where the custom notification event is based on a comparison of the determined estimated time of arrival to an estimated time of arrival specified by the system.
